(19) United States
(12) Patent Application Publication
(10) Pub. No.: US 2009/0115697 A1
(43) Pub. Date: May 7, 2009

(54) Plasma display device and driving method thereof

(76) Inventors: Woo-Joon Chung, Suwon-si (KR); Seung-Min Kim, Suwon-si (KR); Tae-Seong Kim, Suwon-si (KR); Suk-Jae Park, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/232,816

(22) Filed: Sep. 24, 2008

(30) Foreign Application Priority Data
Nov. 2, 2007 (KR) 10-2007-0111554

(51) Int. Cl. G09G 3/28

(52) U.S. Cl. 345/60

(57) ABSTRACT

In a plasma display device and a driving method thereof, a scan voltage is set to be lower than a reset minimum voltage in order to reduce an address discharge delay in an address period. In addition, in the address period, an address voltage and a scan voltage are set to be lower. In order to prevent misfiring in the address period, a voltage biasing a sustain electrode in the address period is set to be lower than a voltage biasing the sustain electrode in a falling period of a reset period.

### CLAIM OF PRIORITY

This application makes reference to, incorporates the same herein, and claims all benefits accruing under 35 U.S.C.§119 from an application for PLASMA DISPLAY DEVICE AND DRIVING METHOD THEREOF earlier filed in the Korean Intellectual Property Office on 2 Nov. 2007 and there duly assigned Serial No. 10-2007-0111554.

### BACKGROUND OF THE INVENTION

1. Field of the Invention

The present invention relates to a plasma display device and a driving method thereof, and more particularly, to a plasma display device for reducing a time applied to an address period and for stably generating an address discharge, and a driving method thereof.

2. Description of the Related Art

A plasma display device is a flat panel display that uses plasma generated by gas discharge to display characters or images. It includes, depending on its size, more than several scores to millions of discharge cells (hereinafter, also referred to as “cells”) arranged in a matrix pattern.

One frame of such a plasma display device is divided into a plurality of subfields having weight values, and each subfield includes a reset period, an address period, and a sustain period. The reset period is for initializing the status of each discharge cell so as to facilitate an addressing operation on the discharge cell. The address period is for selecting turn-on/turn-off cells (i.e., cells to be turned on or off). In addition, the sustain period is for causing the cells to either discharge for displaying an image on the addressed cells or to remain inactive. A frame is a unit of the input image signal (i.e., video signal).

In general, during the reset period, to initialize a wall charge state of the cell, a voltage at a scan electrode is gradually increased to a reset maximum voltage, and gradually decreased to a reset minimum voltage. In addition, during the address period, an address voltage and a scan voltage are respectively applied to an address electrode and the scan electrode of a turn-on cell. Generally, the scan voltage and the reset minimum voltage have approximately same voltage levels.

As described, when the scan voltage and the reset minimum voltage have approximately same voltage levels, an address discharge may be inappropriately generated in a cell selected to be turned on during the address period, that is, a low discharge may be generated. When time periods for respectively applying the scan voltage and the address voltage to the scan electrode and the address electrode to prevent the low discharge are set to be long, the address period may be increased.

The above information disclosed in this Background section is only for the enhancement of understanding of the background of the invention and therefore it may contain information that does not form the prior art that is already known in this country to one of ordinary skill in the art.

### SUMMARY OF THE INVENTION

It is therefore one object of the present invention to provide an improved plasma display device and a driving method thereof in order to overcome the disadvantageous low plasma.

It is another object of the present invention to provide a plasma display device for reducing a time applied to an address period and for stably generating an address discharge, and a driving method thereof.

In an exemplary driving method for driving a plasma display device, the driving method including during driving the plasma display device comprising a plurality of first electrodes and a plurality of second electrodes arranged in a same direction as the plurality of first electrodes with one frame of an input video signal being divided into a plurality of subfields by the plasma display device, in a first period of a reset period of at least one subfield among the plurality of subfields, maintaining a first potential at the plurality of first electrodes to be a first potential level, and gradually decreasing a voltage difference with a first slope with the voltage difference being obtained by subtracting the first potential at the plurality of first electrodes from a second potential at the plurality of second electrodes; in a second period of the reset period, gradually decreasing the voltage difference with a second slope gentler than the first slope; and in an address period following the reset period, while the first potential at the plurality of first electrodes is maintained at a third potential level that is lower than the first potential level, applying a pulse having a fourth potential level to a selected one of the plurality of second electrodes. A fifth potential level and a sixth potential level lower than the fifth potential level are alternately applied to the plurality of first electrodes and the plurality of second electrodes in a sustain period while having opposite phases. In this case, the first potential level is same as the fifth potential level. The second potential at the plurality of second electrodes is gradually decreased to a seventh potential level with the first slope during the second period of the reset period, and the seventh potential level is higher than the fourth potential level. The plurality of first electrodes may be floated during the second period of the reset period, or the first potential at the plurality of first electrodes is gradually decreased to an eighth potential level with a slope that is gentler than the first slope during the second period of the reset period. In this case, the eighth potential level is equal to or lower than the third potential level. An absolute value of the third potential level is the same as the absolute value of a voltage at which a discharge is started to be generated between the first and second electrodes.

In another exemplary driving method of a plasma display device including a plurality of first electrodes and a plurality of second electrodes with one frame being divided into a plurality of subfields respectively having weights, a first potential at the plurality of second electrodes is gradually decreased during a first period of a reset period while maintaining a second potential at the plurality of first electrodes to be a first potential level, the second potential at the plurality of second electrodes is gradually decreased from a second potential level to a fourth potential level during a second period of the reset period while gradually decreasing the first potential at the plurality of first electrodes to a third potential level, and a sixth potential level that is lower than the fourth potential level is applied to a second electrode to be selected among the plurality of second electrodes during an address period while maintaining the first potential at the plurality of first electrodes to be a fifth potential level that is lower than the first potential level. During a sustain period, a seventh potential level and an eighth potential level that is lower than the seventh potential level are alternately applied to the plurality of first electrodes and the plurality of second electrodes while having opposite phases. Here, the first potential level is same as the seventh potential level and the third potential level is same as or higher than the fifth potential level.

In an exemplary driving method of a plasma display device including a plurality of first electrodes and a plurality of second electrodes with one frame being divided into a plurality of subfields respectively having weights, a second potential at the plurality of second electrodes is gradually decreased to a second potential level during a first period of a reset period while maintaining a first potential at the plurality of first electrodes to be a first potential level, the second potential at the plurality of second electrodes is gradually decreased from the second potential level to a third potential level during a second period of the reset period while floating the plurality of first electrodes, and a fifth potential level that is lower than the third potential level is applied to the second electrode to be selected among the plurality of second electrodes during an address period while maintaining the first potential at the plurality of first electrodes to be a fourth potential level that is lower than the first potential level. A sixth potential level that is higher than a fifth potential level and a seventh potential level that is lower than the sixth potential level are alternately applied to the plurality of first electrodes and the plurality of second electrodes during a sustain period while having opposite phases. In this case, the first potential level is same as the sixth potential level.

In the second period of the reset period, a slope decreasing the voltage at the plurality of first electrodes is the same as the slope decreasing the voltage at the plurality of second electrodes. At a time when the second period of the reset period ends, the voltage at the plurality of first electrodes is a sixth potential level and the sixth potential level is same as or higher than the fourth potential level.

An exemplary plasma display device constructed as an embodiment of the present invention includes a plasma display panel and a driver. The plasma display panel includes a plurality of first electrodes and a plurality of second electrodes arranged in the same direction as the plurality of first electrodes. The driver applies driving voltages to the plurality of first electrodes and the plurality of second electrodes. In this case, the driver applies a voltage waveform that gradually decreases to a fourth voltage to the plurality of second electrodes in a first period including a point of time of applying a second voltage to the plurality of first electrodes after applying a voltage waveform that is gradually decreased from a first voltage to a second voltage to the plurality of first electrodes and applying a third voltage to the plurality of second electrodes in a part of a reset period, and the driver applies a fifth voltage lower than the first voltage to the plurality of second electrodes and applying a sixth voltage lower than the second voltage to a first electrode to be selected among the plurality of first electrodes in an address period.

Further, the driver applies a seventh voltage and an eighth voltage lower than the seventh voltage to the plurality of first electrodes and the plurality of second electrodes in a sustain period while having opposite phases. Here, the third voltage has the same voltage level as the seventh voltage, and the fourth voltage is the same as or higher than the fifth voltage.

An exemplary plasma display device constructed as another embodiment of the present invention includes a plasma display panel and a driver. The plasma display panel includes a plurality of first electrodes and a plurality of second electrodes arranged in the same direction as the plurality of first electrodes. The driver applies driving voltages to the plurality of first electrodes and the plurality of second electrodes. In addition, the driver floats the plurality of second electrodes in a first period including a point of time of applying a second voltage to the plurality of first electrodes after applying a driving waveform that gradually decreases from a first voltage to the second voltage to the plurality of first electrodes and applying a third voltage to the plurality of second electrodes in a part of a reset period, and the driver applies a fourth voltage lower than the first voltage to the plurality of second electrodes and applies a fifth voltage lower than the second voltage to the first electrode to be selected among the plurality of first electrodes in an address period.

Further, the driver applies a sixth voltage and a seventh voltage that is lower than the sixth voltage to the plurality of first electrodes and the plurality of second electrodes in a sustain period while having opposite phases. The third voltage has the same voltage level as the sixth voltage.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic diagram of a plasma display device constructed as an exemplary embodiment of the present invention;

FIG. 2 is a group of waveforms representing driving waveforms of the plasma display device constructed as a first exemplary embodiment of the present invention;

FIG. 3 is a group of waveforms representing the driving waveforms of the plasma display device constructed as a second exemplary embodiment of the present invention;

FIG. 4 is a group of waveforms representing the driving waveforms of the plasma display device constructed as a third exemplary embodiment of the present invention; and

FIG. 5 is a group of waveforms representing the driving waveforms of the plasma display device constructed as a fourth exemplary embodiment of the present invention.

### DETAILED DESCRIPTION OF THE INVENTION

In the following detailed description, only certain exemplary embodiments of the present invention will be shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Wall charges mentioned in the following description mean charges formed and accumulated on a wall (e.g., a dielectric layer) close to an electrode of a discharge cell. A wall charge will be described as being “formed” or “accumulated” on the electrode, although the wall charges do not actually touch the electrodes. Further, a wall voltage means a potential difference formed on the wall of the discharge cell by the wall charge.

A plasma display device constructed as an exemplary embodiment of the present invention and a driving method thereof will be described.

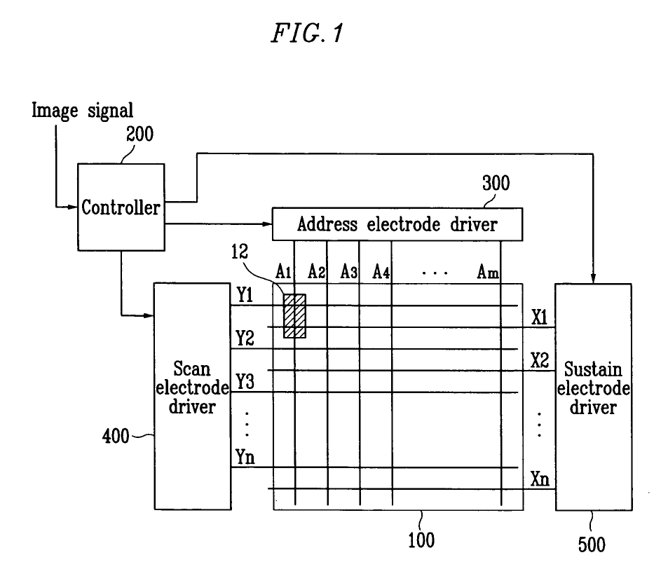

FIG. 1 is a schematic diagram of a plasma display device constructed as the exemplary embodiment of the present invention.

As shown in FIG. 1, the plasma display device constructed as the exemplary embodiment of the present invention includes a plasma display panel (PDP) 100, a controller 200, an address electrode driver 300, a scan electrode driver 400, and a sustain electrode driver 500. PDP 100 includes a plurality of address electrodes A1 to Am extending in a column direction, and a plurality of sustain electrodes X1 to Xn and a plurality of scan electrodes Y1 to Yn extending in a row direction. The plurality of Y electrodes Y1 to Yn and X electrodes X1 to Xn are arranged in Y-X pairs. Discharge cells 12 are formed at intersections of adjacent Y electrodes Y1 to Yn and X electrodes X1 to Xn, and A electrodes A1 to Am.

Controller 200 receives a video signal from the exterior to output an address electrode driving control signal to address electrode driver 300, a sustain electrode driving control signal to sustain electrode driver 500, and a scan electrode driving control signal to scan electrode driver 400. In addition, controller 200 divides one frame of the video signal into a plurality of subfields respectively having according weight values.

Address electrode driver 300 receives the address electrode driving control signal from controller 200 to apply a signal for selecting a desired discharge cell to A electrodes A1 to Am. Scan electrode driver 400 receives the scan electrode driving control signal from controller 200 to apply a driving voltage to Y electrodes Y1 to Yn, and sustain electrode driver 500 receives the sustain electrode driving control signal from controller 200 to apply the driving voltage to X electrodes X1 to Xn.

Driving waveforms of the plasma display device constructed as the exemplary embodiment of the present invention will now be described. For convenience of description, the driving waveform applied to the Y, X, and A electrodes forming one cell will be described.

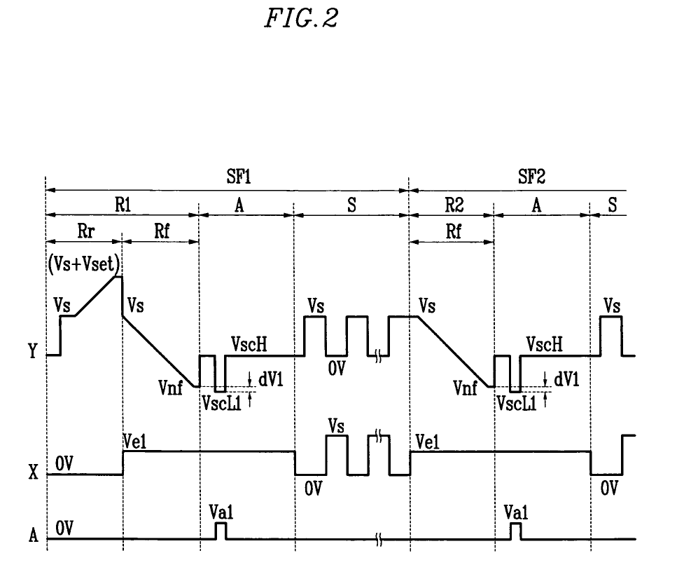

FIG. 2 is a diagram representing the driving waveforms of the plasma display device constructed as a first exemplary embodiment of the present invention.

In FIG. 2, two adjacent subfields, among the plurality of subfields divided from one frame of the video signal, are illustrated, and the two subfields are referred to as a first subfield SF1 and a second subfield SF2. In this case, a reset period R1 of first subfield SF1 is illustrated as a main reset period including a reset rising period Rr and a reset falling period Rf, and the reset period R2 of second subfield SF2 is illustrated as an auxiliary reset period including reset falling period Rf. Here, a reset discharge for initializing the wall charge state is generated in all discharge cells during main reset period R1, and during auxiliary reset period R2, the reset discharge is generated in some cells in which a sustain discharge is generated in a previous subfield.

As shown in FIG. 2, during rising period Rr of reset period R1 of first subfield SF1, while a voltage at the A and X electrodes are maintained at a reference voltage (0V in FIG. 2, and 0V will be referred to as a “0V voltage”), a voltage at the Y electrode is gradually increased from a predetermined voltage (Vs in FIG. 2, and Vs will be referred to as a “rising start voltage”) to a reset maximum voltage ((Vs+Vset) in FIG. 2). In this case, the reset maximum voltage is set to be sufficiently high to generate a discharge in all cells regardless of the wall charge state of the plurality of cells.

While the voltage at the Y electrode is gradually increased during rising period Rr, since a weak discharge (hereinafter referred to as a “reset discharge”) is generated between the Y and X electrodes and between the Y and A electrodes, (−) negative wall charges are formed on the Y electrode, and (+) positive wall charges are formed on the X and A electrodes.

In addition, during falling period Rf of reset period R1, while the voltage at the A electrode and the voltage at the X electrode are respectively maintained at 0V voltage and a first bias voltage (Ve1 in FIG. 2, and Ve1 will be referred to as a “Ve1 voltage”), the voltage at the Y electrode is gradually decreased from the predetermined voltage (Vs in FIG. 2 and Vs will also be referred to as a “falling start voltage”) to a reset minimum voltage (Vnf in FIG. 2, and Vnf will be referred to as a “Vnf voltage”).

While the voltage at the Y electrode is gradually decreased during the falling period Rf, since the reset discharge is generated between the Y and X electrodes and between the Y and A electrodes, the (−) negative wall charges formed on the Y electrode and the (+) positive wall charges formed on the X and A electrodes are eliminated.

Here, a voltage difference (Ve−Vnf) between the Ve1 voltage applied to the X electrode and the Vnf voltage applied to the Y electrode is set close to a voltage at which a discharge is generated between the X and Y electrodes (hereinafter referred to as an “X-Y discharge firing voltage”). Thereby, at a finishing point of the reset period, since a wall voltage between the X and Y electrodes become close to the 0V voltage, the sustain discharge is prevented during a sustain period from the cell that is not selected to be light-emitted.

Subsequently, during address period A, to select a cell to be light-emitted in first subfield SF1 (hereinafter referred to as a “light emitting cell”), while the voltage at the X electrode is maintained at the Ve1 voltage, a first scan voltage (VscL1 in FIG. 2 and referred to as a “VscL1 voltage”) is sequentially applied to the plurality of Y electrodes. In this case, a first address voltage (Va1 in FIG. 2 and referred to as a “Va1 voltage”) is applied to the A electrode forming the cell selected as the light emitting cell among the cells formed by the Y electrode to which the VscL1 voltage is applied. Thereby, a discharge (hereinafter referred to as an “A-Y address discharge”) is generated between the A electrode receiving the Va1 voltage and the Y electrode receiving the VscL1 voltage, and a discharge (hereinafter referred to as an “X-Y address discharge”) is generated between the X electrode receiving the Ve1 voltage and the Y electrode receiving the VscL1 voltage by the A-Y address discharge. The (+) positive wall charges are formed on the Y electrode and the (−) negative wall charges are formed on the X and A electrodes by the A-Y address discharge and the X-Y address discharge. In addition, as shown in FIG. 2, a non-scan voltage (VscH in FIG. 2, and referred to as a “VscH voltage”) that is higher than the VscL1 voltage is applied to the Y electrodes in which the VscL1 voltage is not applied.

In addition, as shown in FIG. 2, VscL1 voltage is set to be lower than Vnf voltage, and a voltage difference (Vnf−VscL1) between Vnf voltage and VscL1 voltage is a dV1 voltage. Thereby, a voltage difference (Ve1−VscL1) between the X and Y electrodes during the address period A is increased to be higher than a voltage difference (Ve1−Vnf) between X and Y electrodes at the finishing point of the reset period by dV1 voltage. Accordingly, since discharge delays of the A-Y address discharge and the X-Y address discharge are reduced, times for respectively applying the VscL1 voltage and the Va1 voltage to the Y electrode and the A electrode may be reduced.

During sustain period S, a sustain pulse of a sustain voltage (Vs in FIG. 2, and referred to as a “Vs voltage”) and the sustain pulse of the 0V voltage are alternately applied to the Y electrode and the X electrode to generated a sustain discharge between the Y and X electrodes. Subsequently, a process for applying the sustain pulse of the Vs voltage to the Y electrode and a process for applying the sustain pulse of the Vs voltage to the X electrode are repeatedly performed a number of times corresponding to the weight of the corresponding subfield.

Reset period R2 of second subfield SF2 includes falling period Rf as the auxiliary reset period.

During the reset period R2 of second subfield SF2, in a like manner of falling period Rf of reset period R1 of first subfield SF1, while the voltage at the X electrode and the voltage at the A electrode are respectively maintained at the Ve1 voltage and 0V voltage, the voltage at the Y electrode is gradually decreased from a falling start voltage (Vs in FIG. 2) to the Vnf voltage. Thereby, while the voltage at the Y electrode is gradually decreased, the reset discharge is generated between the Y and X electrodes and between the Y and A electrodes in the sustain-discharged cell during sustain period S of the first subfield SF1.

Since the operations of address period A and sustain period S in second subfield SF2 are the same as or similar to those of first subfield SF1, detailed descriptions thereof will be omitted.

As described, according to the first exemplary embodiment of the present invention, since the discharge delay of the A-Y address discharge and the X-Y address discharge is reduced in the address period by establishing the VscL1 voltage to be lower than Vnf voltage, the times for respectively applying the VscL1 and the Va1 voltages to the Y electrode and the A electrode may be reduced, and the time of the address period may be reduced.

In addition, the address electrode driver for applying the driving voltage to the A electrode is electrically connected to a power source for supplying the address voltage. In this case, since an internal voltage applied to elements in the address electrode driver is reduced as the address voltage is set to be lower, the elements in the address electrode driver may be prevented from being deteriorated or being damaged, and circuit reliability may be improved.

If a voltage level of the address voltage is set to be lower as described, the A-Y address discharge may be stably generated during the address period when the voltage level of the scan voltage is set to be lower. When the voltage level of the scan voltage is set to be low, however, a discharge may be generated by a bias voltage applied to the X electrode and the scan voltage applied to the Y electrode in the cell selected as a non-light emitting cell in the address period, that is, a misfire may be generated.

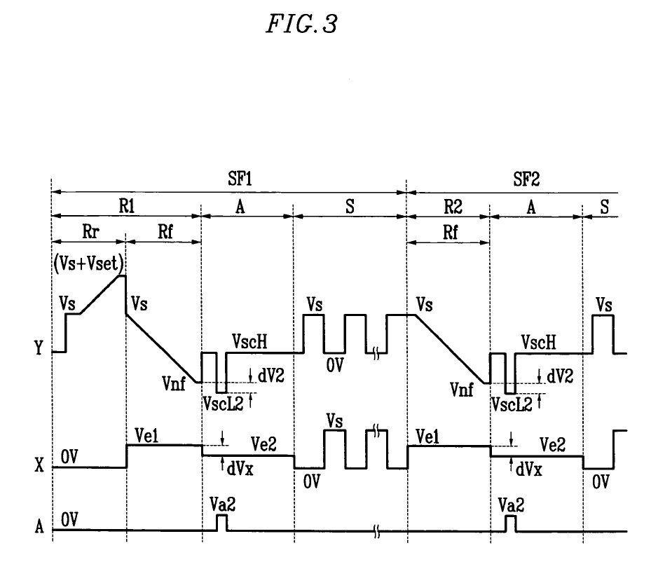

Hereinafter, the driving waveforms for reducing the address period, decreasing the voltage level of the address voltage, and preventing misfiring during the address period will be described. FIG. 3 is a group of waveforms representing the driving waveforms of the plasma display device constructed as a second exemplary embodiment of the present invention.

According to the second exemplary embodiment of the present invention, the X electrode is biased at the Ve1 voltage during the falling period of the reset period, and the X electrode is biased at a second bias voltage (Ve2 in FIG. 3, and referred to as a “Ve2 voltage”) that is lower than the Ve1 voltage during the address period. In the second exemplary embodiment of the present invention, since the rising period of the reset period and the sustain period are the same as those according to the first exemplary embodiment of the present invention, parts having been described will be omitted.

As shown in FIG. 3, during rising period Rr of reset period R1 in first subfield SF1, while the 0V voltage is applied to the X electrode and the A electrode, a voltage waveform gradually increasing from a rising start voltage (Vs in FIG. 3) to the reset maximum voltage is applied to the Y electrode. While the voltage at the Y electrode is gradually increased, the reset discharge is generated between the Y and X electrodes and between the Y and A electrodes, and therefore (−) negative wall charges are formed on the Y electrode and the (+) positive wall charges are formed on the X and A electrodes.

In addition, according to the second exemplary embodiment of the present invention, during falling period Rf of reset period R1 in first subfield SF1, while the 0V voltage is applied to the A electrode and the Ve1 voltage is applied to the X electrode, a voltage waveform that gradually decreases from the falling start voltage (Vs in FIG. 3) to the Vnf voltage is applied to the Y electrode. While the voltage at the Y electrode is gradually decreased, the reset discharge is generated between the Y and X electrodes and between the Y and A electrodes, and therefore wall charges formed on the Y, X, and A electrodes are eliminated. In this case, the voltage difference (Ve1−Vnf) between the X and Y electrodes is set close to the X-Y discharge firing voltage at a finishing point of falling period Rf, so that the wall voltage between the X and Y electrodes after the falling period Rf is finished may be the 0V voltage.

During address period A, the second bias voltage (Ve2 in FIG. 3, and referred to as a “Ve2 voltage”) is applied to the X electrode, a second scan voltage (VscL2 in FIG. 3, and referred to as a VscL2 voltage) is sequentially applied to the plurality of Y electrodes. In this case, a second address voltage (Va2 in FIG. 3, and referred to as a “Va2 voltage) is applied to the A electrode forming the cell selected as the light emitting cell among the cells formed by the Y electrode to which the VscL2 voltage is applied. In addition, the Y electrode to which the VscL2 voltage is not applied is maintained at the VscH voltage. Thereby, the A-Y address discharge is generated between the A electrode to which the Va2 voltage is applied and the Y electrode to which the VscL2 voltage is applied, and the X-Y address discharge is generated between the X electrode receiving the Ve2 voltage and the Y electrode receiving the VscL2 voltage by the A-Y address discharge. By the A-Y address discharge and the X-Y address discharge, the (+) positive wall charges are formed on the Y electrode, and the (−) negative wall charges are formed on the X electrode and the A electrode.

The Va2 voltage is lower than the Va1 voltage, the Ve2 voltage is lower than the Ve1 voltage, and the Ve2 voltage is a voltage that is reduced from the Ve1 voltage by a dVx voltage. In addition, the VscL2 voltage is lower than the VscL1 voltage, the voltage difference (Vnf−VscL2) between the Vnf voltage and the VscL2 voltage is a dV2 voltage, and the dV2 voltage is higher than the dV1 voltage.

That is, according to the second exemplary embodiment of the present invention, since the scan voltage is set to be reduced from the VscL1 voltage to the VscL2 voltage as the address voltage is set to be reduced from the Va1 voltage to the Va2 voltage, the discharge may be stably generated in the cell selected as the light emitting cell during the address period. In addition, since the scan voltage is set to be reduced to be the VscL2 voltage, the voltage difference (Vnf−VscL2) between the reset minimum voltage and the scan voltage is increased to be the dV2 voltage. In this case, in a like manner of falling period Rf, when the X electrode is biased at the Ve1 voltage during address period A, the discharge may be generated in the non-light emitting cell during the address period, that is, the misfiring may be generated. To prevent the misfiring, as the scan voltage is reduced, the bias voltage is also reduced to be the Ve2 voltage that is lower than the Ve1 voltage by the dVx voltage.

During sustain period S, since the sustain pulse of the Vs voltage and the sustain pulse of the 0V voltage are alternately applied to the X electrode and the Y electrode, the sustain discharge is generated between the X and Y electrodes a number of times corresponding to the weight of the corresponding subfield.

Since reset period R2 of second subfield SF2 is the same as falling period Rf of the first subfield SF1, and address and sustain periods A and S of second subfield SF1 are the same as address and sustain period A and S of first subfield SF1, parts having been described will be omitted.

As described, according to the second exemplary embodiment of the present invention, since the address voltage is set to be the Va2 voltage that is lower than the Va1 voltage and the scan voltage is set to be the VscL2 voltage that is lower than the VscL1 voltage, the bias voltage applied to the X electrode during address period is set to be the Ve2 voltage that is lower than the Ve1 voltage. Accordingly, in addition to reducing the address voltage, the misfiring during the address period may be prevented.

In addition, according to the second exemplary embodiment of the present invention, since the voltage (Ve1 voltage) applied to the X electrode during the falling period of the reset period is set to have a voltage level that is different from the voltage (Ve2 voltage) applied to the X electrode during the address period to prevent the misfiring, it is required to separately provide a power source for supplying the Ve1 voltage and a power source for supplying the Ve2 voltage. Accordingly, the manufacturing cost of the plasma display device is increased, and it is difficult to simplify a configuration thereof.

Hereinafter, a driving method for preventing the misfiring during the address period without increasing the number of power sources will be described.

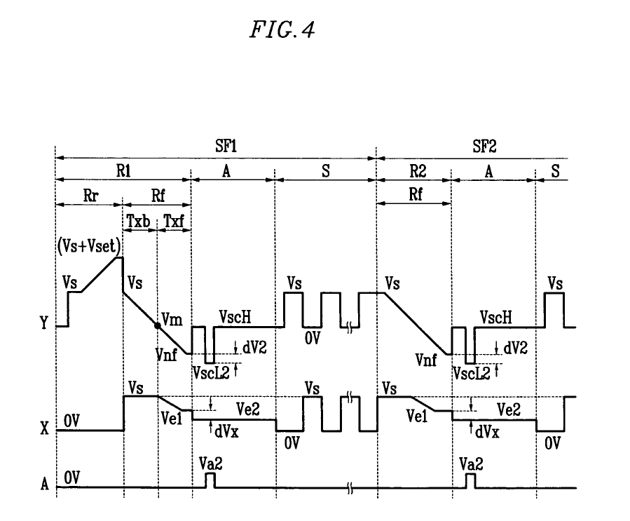

FIG. 4 is a diagram representing the driving waveforms of the plasma display device constructed as a third exemplary embodiment of the present invention.

According to the third exemplary embodiment of the present invention, during the falling period Rf of the reset period, after the X electrode is biased to the Vs voltage, the voltage at the X electrode is gradually decreased during a part of the reset period Rf including the finishing point of the falling period Rf. Since the reset period in the third exemplary embodiment of the present invention is the same as that of the second exemplary embodiment of the present invention except that the voltage at the X electrode is gradually decreased during the part of the reset period, parts having been described will be omitted.

According to the third exemplary embodiment of the present invention, during the rising period Rr of the reset period R in the first subfield SF1, while the 0V voltage is applied to the X and A electrodes, the voltage at the Y electrode is gradually increased from the rising start voltage (Vs in FIG. 4) to the reset maximum voltage ((Vs+Vset) in FIG. 4).

During the falling period Rf of the reset period R in the first subfield SF1, while the 0V voltage is applied to the A electrode, the voltage at the Y electrode is gradually decreased from the falling start voltage (Vs in FIG. 4) to the Vnf voltage. In this case, in a period (Txb in FIG. 4 and refereed to as a “Txb period”) including the starting point of the falling period, the X electrode is maintained at the Vs voltage. Thereby, while the voltage at the Y electrode is gradually decreased, the reset discharge is generated between the X and Y electrodes and the A and Y electrodes.

In this case, during the period Txb, a voltage gradually decreased with a first slope, the voltage obtained by subtracting the voltage at the X electrode from a voltage at the Y electrode. The first slope is ((Vs−Vm)/Txb) as a consequence of (((Vs−Vs)−(Vm−Vs))/Txb). Here, Vm voltage is a voltage of the Y electrode at an end point of the period Txb.

In addition, since the Vs voltage is higher than the Ve1 voltage, if the X electrode is biased at the Vs voltage to the finishing point during the reset period, the voltage difference between the X and Y electrodes becomes higher than the X-Y discharge firing voltage at the finishing point of the reset period.

That is, the voltage difference (Ve1−Vnf) between the X and Y electrodes is set close to the X-Y discharge firing voltage at the finishing point of the reset period in the second exemplary embodiment of the present invention, but the reset discharge is excessively generated in the third exemplary embodiment of the present invention since the X electrode is biased at the Vs voltage that is higher than the Ve1 voltage.

Accordingly, according to the third exemplary embodiment of the present invention, the voltage at the X electrode is gradually decreased from the Vs voltage to the Ve1 voltage during a period (Txf in FIG. 4 and referred to as a “Txf period”) including the finishing point of the falling period so that the wall voltage between the X and Y electrodes becomes close to the 0V voltage at the finishing point of the reset period.

Thereby, during the period Txf, since the voltage at the X electrode is reduced, a voltage gradually decreased with a second slope that is gentler than the first slope, the voltage obtained by subtracting the voltage at the X electrode from a voltage at the Y electrode. Here, the second slope is (((Vm−Vs)−(Vnf−Ve1))/Txf).

Accordingly, since a slope decreasing the voltage difference between the X and Y electrodes becomes gentler as the voltage at the X electrode is gradually decreased during the period Txf, the reset discharge may be further weakly generated, or the reset discharge may not be generated. Thereby, since the wall voltage between the X and Y electrodes becomes close to the 0V voltage at the finishing point of falling period Rf, the misfiring in the non-light emitting cell during the sustain period may be prevented.

Subsequently, during address period A of the first subfield SF1, while the Ve2 voltage that is lower than the Ve1 voltage by the dVx voltage is applied to the X electrode, the VscL2 voltage is sequentially applied to the plurality of Y electrodes. The Va2 voltage is applied to the A electrode forming the cell selected as the light emitting cell among the cells formed by the Y electrode to which the VscL2 voltage is applied. In this case, the VscH voltage is applied to Y electrodes to which VscL2 voltage is not applied.

According to the third exemplary embodiment of the present invention, since the second subfield SF2 and the sustain period S of the first subfield SF1 are the same as those of the second exemplary embodiment of the present invention, parts having been described will be omitted.

As described, according to the third exemplary embodiment of the present invention, to prevent the misfiring or the low discharge during the address period as the voltage difference between the reset minimum voltage and the scan voltage increases, the voltages biasing the voltage at the X electrode during the address period and the falling period of the reset period may be respectively set to be different from each other. That is, the Ve2 voltage is applied to the X electrode during the address period, and the voltage at the X electrode is gradually decreased during the falling period of the reset period after the voltage at the X electrode is maintained at the Vs voltage. In this case, the voltage at the X electrode may be the Ve1 voltage or the Ve2 voltage at the finishing point of the reset period. In addition, since the reset discharge is weakly generated or it is not generated while the voltage at the X electrode is gradually decreased, the wall voltage between the X and Y electrodes becomes close to the 0V voltage at the finishing point of the reset period.

Further, during the address period, since the voltage difference (Ve2−VscL2) between the X electrode and the Y electrode is set to be higher than the voltage difference (Ve1−Vnf) between the X and Y electrodes at the finishing point of the reset period by a (dVx−dV2) voltage, the discharge may not be generated in the cell that is not selected as the light emitting cell during the address period, that is, the misfiring may be prevented.

Therefore, according to the third exemplary embodiment of the present invention, without using an additional power source, the reset discharge may be appropriately generated during the reset period, and the misfiring may be prevented during the address period.

In addition, according to the third exemplary embodiment of the present invention, during the Txf period of the falling period Rf, the voltage at the X electrode is gradually decreased. In this case, to gradually decrease the voltage at the X electrode, it is required to additionally provide a ramp switch for gradually decreasing the voltage at the X electrode in the sustain electrode driver 500 for applying the driving voltage to the X electrode. That is, the ramp switch may be coupled to a voltage source such as the voltage source for supplying the voltage Ve2 or the ground terminal, and may be operated to be turned off when the voltage at the X electrodes is decreased to the voltage Ve1 that is equal to or higher than the voltage Ve2. Then, the additional voltage source for supplying the voltage Ve1 may be not required. However, as described, according to the third exemplary embodiment of the present invention, an additional switch may be required for gradually decreasing the voltage at the X electrode during the Txf period. When the flnction generator power supply is used for supplying the voltages of Ve1 and Ve2, it should have an additional circuit for generating the voltage of Ve1 from the voltage of Ve2, which leads to an increase in the cost.

Hereinafter, a driving method for gradually decreasing the voltage at the X electrode during the Txb period without providing an additional element will now be described.

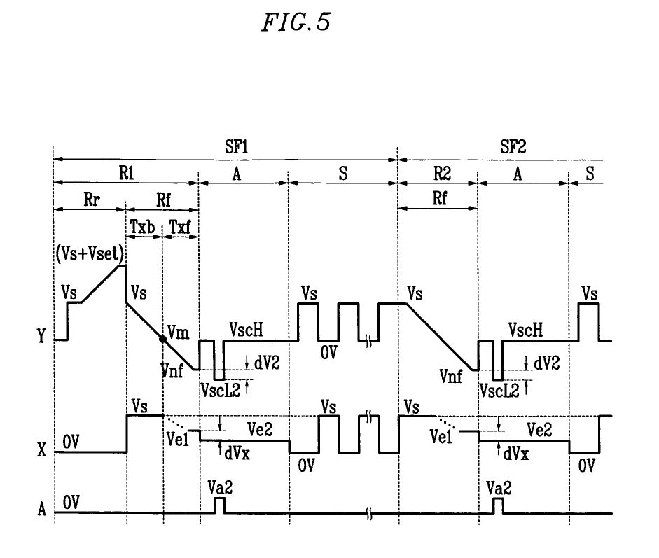

FIG. 5 is a diagram representing the driving waveforms of the plasma display device constructed as a fourth exemplary embodiment of the present invention.

According to the fourth exemplary embodiment of the present invention, during the falling period Rf of the reset period, after the voltage at the X electrode is maintained at the Vs voltage while the voltage at the Y electrode is gradually decreased, the voltage at the X electrode is floated during a period (Txf) including a time when the voltage at the Y electrode becomes the Vnf voltage. Since the driving waveforms according to the fourth exemplary embodiment of the present invention are the same at those of the third exemplary embodiment of the present invention except that the voltage at the X electrode is floated during the Txf period, parts having been described will be omitted. In FIG. 5, since an additional voltage source for supplying the voltage Ve1 is not used, the voltage of Ve1 is not applied to the X electrodes. The X electrode is floated until the voltage of the X electrode is decreased to the voltage of Ve1 such that the voltage of the X electrode can be the voltage of Ve1.

According to the fourth exemplary embodiment of the present invention, during the rising period Rr of the reset period R in the first subfield SF1, while the 0V voltage is applied to the X and A electrodes, the voltage at the Y electrode is gradually increased from the rising start voltage (Vs in FIG. 5) to the reset maximum voltage ((Vs+Vset) in FIG. 5).

Subsequently, during the Txb period of the falling period Rf, while the 0V voltage and the Vs voltage are respectively applied to the A electrode and the X electrode, the voltage waveform that gradually decreases from the falling start voltage (Vs in FIG. 5) is applied to the Y electrode. Thereby, during the period Txb, a voltage gradually decreased with the first slope, the voltage obtained by subtracting the voltage at the X electrode from a voltage at the Y electrode. Accordingly, the reset discharge is generated between the X and Y electrodes and the A and Y electrodes. Here, the first slope is ((Vs−Vm)/Txb), in a like manner of the third exemplary embodiment of the present invention.

During the Txf period of the falling period Rf that is subsequent to the Txb period, the X electrode is floated while the voltage waveform that gradually decreases the Vnf voltage is applied to the Y electrode.

Thereby, during the period Txf, since the voltage at the X electrode is reduced as the voltage at the Y electrode varies, a voltage gradually decreased with the second slope that is gentler than the first slope, the voltage obtained by subtracting the voltage at the X electrode from a voltage at the Y electrode. Here, the second slope is (((Vm−Vs)−(Vnf−Ve1))/Txf), in a like manner of the third exemplary embodiment of the present invention. Therefore, the reset discharge is further weakly generated between the X and Y electrodes or the reset discharge may not be generated. Accordingly, at the finishing point of the falling period, the wall voltage between the X and Y electrodes becomes close to the 0V voltage.

Since the second subfield SF2 and the address period A of the first subfield SF1 in the fourth exemplary embodiment of the present invention are the same as those of the third exemplary embodiment of the present invention, parts having been described will be omitted.

As described, according to the fourth exemplary embodiment of the present invention, without providing an additional element for gradually decreasing the voltage at the X electrode, the wall charge state may be appropriately initialized since the X electrode is floated during the Txf period of the falling period of the reset period, and the wall voltage between the X and Y electrodes is set close to the 0V voltage at the finishing point of the reset period.

In addition, in FIG. 2 to FIG. 5, while the reset rising and falling waveforms applied to the Y electrode are illustrated as ramp waveforms, gradually increasing or decreasing waveforms such as an RC waveform and a waveform that is floated while gradually increasing or gradually decreasing may be applied to the reset rising waveform or the reset falling waveform in the exemplary embodiment of the present invention.

In addition, in FIG. 4 and FIG. 5, while the bias voltage at the X electrode is illustrated as the Vs voltage during the Txb period of the falling period of the reset period, a voltage level, such as the Vset voltage, that is higher than the Ve1 voltage and that may be used during other periods may be used as the voltage for biasing the X electrode during the Txb period.

Further, in FIG. 4 and FIG. 5, the time applied to the Txf period may be adjusted for the respective subfields according to the amount of wall charges to be eliminated. That is, since the Txf period is set to be short when the amount of wall charges to be eliminated during the reset period of the corresponding subfield is large, the reset discharge is adjusted to be generated long between the X and Y electrodes. In addition, since the Txf period is set to be long when the amount of wall charges to be eliminated during the reset period of the corresponding subfield is less, the wall charges formed on the X and Y electrodes are appropriately eliminated.

According to the exemplary embodiment of the present invention, the voltage level of the address voltage may be reduced, and the address period may be reduced. In addition, the misfiring may be prevented without providing an additional power source.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving method for driving a plasma display device, the driving method comprising:
during driving the plasma display device comprising a plurality of first electrodes and a plurality of second electrodes arranged in a same direction as the plurality of first electrodes with one frame of an input video signal being divided into a plurality of subfields by the plasma display device, in a first period of a reset period of at least one subfield among the plurality of subfields, maintaining a first potential at the plurality of first electrodes to be a first potential level, and gradually decreasing a voltage difference with a first slope with the voltage difference being obtained by subtracting the first potential at the plurality of first electrodes from a second potential at the plurality of second electrodes;
in a second period of the reset period, gradually decreasing the voltage difference with a second slope gentler than the first slope; and
in an address period following the reset period, while the first potential at the plurality of first electrodes is maintained at a third potential level that is lower than the first potential level, applying a pulse having a fourth potential level to a selected one of the plurality of second electrodes.

2. The driving method of claim 1, further comprising, in a sustain period, alternately applying a fifth potential level and a sixth potential level lower than the fifth potential level respectively to the plurality of first electrodes and the plurality of second electrodes with the first potential at the plurality of first electrodes having opposite phases compared to the second potential at the plurality of second electrodes.

3. The driving method of claim 2, in which the first potential level has the same level as the fifth potential level.

4. The driving method of claim 1, in which the second potential at the plurality of second electrodes is decreased to a seventh potential level with the first slope, and the seventh potential level is higher than the fourth potential level.

5. The driving method of claim 4, in which the plurality of first electrodes are floated during the second period of the reset period.

6. The driving method of claim 4, in which the first potential at the plurality of first electrodes is decreased to an eighth potential level with a third slope gentler than the first slope during the second period of the reset period.

7. The driving method of claim 6, in which the eighth potential level is equal to or lower than the third potential level.

8. The driving method of claim 1, in which an absolute value of the third potential level is the same as the absolute value of a voltage at which a discharge is started to be generated between the first and second electrodes.

9. A driving method for driving a plasma display device, the driving method comprising:
during a first period of a reset period of driving the plasma display device for dividing one frame into a plurality of subfields respectively having weights, with the plasma display device comprising a plurality of first electrodes and a plurality of second electrodes, gradually decreasing a second potential at the plurality of second electrodes while maintaining a first potential at the plurality of first electrodes to be a first potential level;
during a second period of a reset period, gradually decreasing the second potential at the plurality of second electrodes from a second potential level to a fourth potential level while gradually decreasing the first potential at the plurality of first electrodes to a third potential level; and
during an address period, applying a sixth potential level that is lower than the fourth potential level to a selected one of the plurality of second electrodes while maintaining the first potential at the plurality of first electrodes to be a fifth potential level lower than the first potential level.

10. The driving method of claim 9, further comprising, during a sustain period, alternately applying a seventh potential level and an eighth potential level lower than the seventh potential level respectively to the plurality of first electrodes and the plurality of second electrodes while the first potential and second potential have opposite phases.

11. The driving method of claim 10, in which the first potential level is same as the seventh potential level.

12. The driving method of claim 9, in which the third potential level is same as or higher than the fifth potential level.

13. A driving method for driving a plasma display device, the driving method comprising:
during a first period of a reset period of driving the plasma display device for dividing one frame into a plurality of subfields respectively having weights with the plasma display device comprising a plurality of first electrodes and a plurality of second electrodes, gradually decreasing a second potential at the plurality of second electrodes to a second potential level while maintaining a first potential at the plurality of first electrodes to be a first potential level;
during a second period of the reset period, gradually decreasing the second potential at the plurality of second electrodes from the second potential level to a third potential level while the plurality of first electrodes is floated; and
during an address period, applying a fifth potential level lower than the third potential level to a selected one of the plurality of second electrodes while maintaining the first potential at the plurality of first electrodes to be a fourth potential level lower than the first potential level.

14. The driving method of claim 13, further comprising, during a sustain period, alternately applying a sixth voltage that is higher than the fifth voltage and a seventh voltage that is lower than the sixth voltage to the plurality of first electrodes and the plurality of second electrodes while the first potential and the second potential have opposite phases.

15. The driving method of claim 14, in which the first potential level is same as the sixth potential level.

16. The driving method of claim 13, in which, in the second period of the reset period, a slope of decreasing the first potential at the plurality of first electrodes is identical to a slope of decreasing the second potential at the plurality of second electrodes.

17. The driving method of claim 13, in which, when the second period of the reset period ends, the first potential at the plurality of first electrodes is a sixth potential level and the sixth potential level is the same as or higher than the fourth potential level.

18. A plasma display device, comprising:
a plasma display panel including a plurality of first electrodes and a plurality of second electrodes arranged in the same direction as the plurality of first electrodes; and
a driver for applying driving voltages to the plurality of first electrodes and the plurality of second electrodes, with the driver applying a voltage waveform that gradually decreases to a fourth potential level to the plurality of second electrodes in a first period including a point of time of applying a second voltage to the plurality of first electrodes after applying the voltage waveform that gradually decreases from a first potential level to a second potential level to the plurality of first electrodes and applying a third potential level to the plurality of second electrodes in a part of a reset period, and applying in an address period a fifth potential level lower than the third potential level to the plurality of second electrodes and applying in the address period a sixth potential level lower than the second potential level to a selected one of the plurality of first electrodes.

19. The plasma display device of claim 18, in which the driver alternately applies a seventh potential level and an eighth potential level lower than the seventh voltage respectively to the plurality of first electrodes and the plurality of second electrodes in a sustain period, while a first potential at the plurality of first electrodes have opposite phases compared to a second potential at the plurality of second electrodes.

20. The plasma display device of claim 19, in which the third potential level is identical to the seventh potential level.

21. The plasma display device of claim 18, in which the fourth potential level is same as or higher than the fifth potential level.

22. A plasma display device, comprising:
a plasma display panel (PDP) including a plurality of first electrodes and a plurality of second electrodes arranged in the same direction as the plurality of first electrodes; and
a driver for applying driving voltages to the plurality of first electrodes and the plurality of second electrodes, with the driver floating the plurality of second electrodes in a first period including a point of time applying a second potential level to the plurality of first electrodes after applying a driving waveform that gradually decreases from a first potential level to the second potential level to the plurality of first electrodes and applying a third potential level to the plurality of second electrodes in a part of a reset period, and applying in an address period a fourth potential level lower than the third potential level to the plurality of second electrodes and applying in the address period a fifth potential level lower than the second potential level to a selected one of the plurality of first electrodes.

23. The plasma display device of claim 22, in which the driver applies a sixth potential level and a seventh potential level lower than the sixth potential level to the plurality of first electrodes and the plurality of second electrodes in a sustain period while a first potential at the plurality of first electrodes have opposite phases compared to a second potential at the plurality of second electrodes.

24. The plasma display device of claim 23, in which the third potential level is identical to the sixth potential level.
